(19) United States
(12) Patent Application Publication
(10) Pub. No.: US 2025/0253079 A1
(43) Pub. Date: Aug. 7, 2025

(54) RARE EARTH MAGNET AND METHOD FOR MANUFACTURING THE SAME

(71) Applicant: HONDA MOTOR CO., LTD., Tokyo (JP)

(72) Inventors: Akihito NINOMIYA, Saitama (JP); Yasutaka SHINTANI, Saitama (JP); Ibuki OTA, Saitama (JP)

(21) Appl. No.: 19/033,144

(22) Filed: Jan. 21, 2025

(30) Foreign Application Priority Data
Feb. 2, 2024 (JP) 2024-014686

(51) Int. Cl. H01F 1/08

(52) U.S. Cl. CPC H01F 1/083

(57) ABSTRACT

Provided is a rare earth magnet and a method for manufacturing the same, which achieve both high magnetic properties and low eddy current loss. The rare earth magnet comprises coated granulated magnet powder particles, each of which comprises a granulated magnet powder particle and a coating of an insulating material on a surface thereof, the granulated magnet powder particle including a plurality of flake-shaped rare earth magnet powder particles bound in layers. The method of manufacturing the rare earth magnet comprises performing a granulating operation which includes binding flake-shaped rare earth magnet powder particles in layers to produce granulated magnet powder particles, and performing a coating operation which includes adding an insulating material to the granulated magnet powder particles to produce coated granulated magnet powder particles 5, each having a coating 4 thereon.

### TECHNICAL FIELD

The present invention relates to a rare earth magnet and a method for manufacturing a rare earth magnet.

### BACKGROUND ART

In recent years, efforts directed toward realizing a low-carbon or a decarbonized society have become more active, and for vehicles, research and development related to electrification technology are also being conducted in order to reduce CO₂ emissions and to improve energy efficiency. Methods for improving energy efficiency include to improve the efficiency of motors used as power sources. Recently, rare earth magnets have been used more and more to improve motor efficiency. Since rare earth magnets are metallic magnets, their electrical resistance is generally low, which causes a problem that incorporating rare earth magnets into a motor increases eddy current loss, which reduces the efficiency of the motor. Various proposals have been made about how to reduce eddy current loss.

Patent Document 1 discloses a rare earth magnet capable of reducing eddy current losses, having rare earth magnet powder particles, each covered with a film-like coating layer containing rare earth oxides. Bond portions containing rare earth oxide particles are interposed between the coated rare earth magnet powder particles. A method of producing the rare earth magnet comprises conducting high temperature and pressure forming of a mixture of rare earth oxides and rare earth magnet powder particles coated with the rare earth oxides.

Patent Document 2 discloses a method of manufacturing a rare earth magnet comprising: mixing Nd—Fe—B magnet powder with an oxide such as CaO, and a nitride such as BN or a fluoride such as CaF₂ for the purpose of high electrical resistance; and processing a resulting mixture by hot plastic molding, to produce an anisotropic magnet.

Patent Document 3 discloses that a first method of manufacturing a rare earth magnet comprises: preparing isotropic rapid-cooled powder particles such as Nd—Fe—B magnet powder particles; mixing the isotropic rapid-cooled powder particles with a predetermined compound for forming insulating layers; processing the mixture by cold molding to produce a cold molded product (temporary molding); and processing the cold molded product by hot molding (densifying); and processing, by hot plastic molding, the resultant product (imparting anisotropy) to produce the rare earth magnet, and that a so-produced magnet includes generally stacked Nd—Fe—B rapid-cooled powder particles with the compound powder material therebetween, each particle having a long side length of 100 to 400 μm and a thickness of 20 to 40 μm.

### PRIOR ART DOCUMENT(S)

### Patent Document(s)

Patent Document 1: JP4784173B
Patent Document 2: JP2003-022905A
Patent Document 3: JP2010-027852A

### SUMMARY OF THE INVENTION

### Task to be Accomplished by the Invention

In order to minimize the deterioration of magnetic properties of a rare earth magnet, it is desirable to reduce the amount of an insulating compound material to be mixed with magnet powder particles. However, since each of the magnet powder particles is flake-shaped, the magnet powder particles are generally stacked in the step of densifying the mixture of magnet powder particles and the insulating compound material. Thus, when performing the method of manufacturing a magnet of the prior art, the process of hot plastic molding (densifying) causes the magnet powder particles and the insulating compound material to deform and spread in directions perpendicular to a pressing direction (i.e., along main surfaces of the magnet powder particles). This means that a decreased amount of insulating compound material is likely to cause breaks in insulating layers during the process of hot plastic molding, thereby forming electrical connections between magnet powder particles, which should have been separated by the insulating layers. In such a case, a larger eddy current path (less effective in breaking up the eddy current path) is formed in the produced magnet, resulting in occurrence of a larger eddy current loss during operation of a motor using the magnet.

The present invention has been made in view of the above-described problem of the prior art, and a primary object of the present invention is to provide a rare earth magnet and a method for manufacturing the same, which achieve both high magnetic properties and low eddy current loss.

### Means to Accomplish the Task

As a solution to the above-described tasks to be accomplished, an aspect of the present invention provides a rare earth magnet (1) comprising coated granulated magnet powder particles (5), each of which comprises a granulated magnet powder particle (3) and a coating (4) of an insulating material on a surface thereof, the granulated magnet powder particle including a plurality of flake-shaped rare earth magnet powder particles (2) bound in layers and stacked in a stacking direction.

In this configuration, the coating does not cover each rare earth magnet powder particle, but rather covers the surface of each granulated magnet powder particle comprising a plurality of rare earth magnet powder particles bound in layers and stacked in a stacking direction, which allows for a decrease in the amount of insulating material required to maintain the thickness of each of the insulating coatings in the rare earth magnet, and an increase in the volume ratio of rare earth magnet powder particles. This minimizes the deterioration of magnetic properties of the rare earth magnet caused by the addition of the insulating material, improving the magnetic properties of the rare earth magnet. In other words, this configuration allows for an increase in the thickness of each coating without increasing the volume ratio of coatings, which prevents the occurrence of breaks in the coatings when the coated granulated magnet powder particles spread in a direction perpendicular to the pressing direction during a molding operation. This suppresses an increase in eddy current loss of the rare earth magnet.

Preferably, the above rare earth magnet may be further configured such that the granulated magnet powder particle has a thickness of 40 μm to 300 μm in the stacking direction.

In this configuration, each granulated magnet powder particle comprises several rare earth magnet powder particles bound in layers, allowing for an effective decrease in the volume ratio of coatings.

Preferably, the above rare earth magnet may be further configured such that the granulated magnet powder particle has a thickness in the stacking direction that is smaller than particle sizes of the rare earth magnet powder particles thereof.

This configuration allows for a decrease in the volume ratio of coatings in the rare earth magnet without compromising the ease of orientation of coated granulated magnet powder particles in a molding operation.

As a solution to the above-described tasks to be accomplished, another aspect of the present invention provides a method for manufacturing a rare earth magnet comprising: binding a plurality of flake-shaped rare earth magnet powder particles (2) in layers to produce granulated magnet powder particles (3), each of which is formed by a plurality of the flake-shaped rare earth magnet powder particles stacked in a stacking direction (FIG. 1(B)); adding an insulating material to the granulated magnet powder particles to produce coated granulated magnet powder particles (5), such that each of the coated granulated magnet powder particles comprises the flake-shaped rare earth magnet powder particles and a coating (4) of the insulating material on a surface thereof (FIG. 1(C)); and performing a compression molding operation, the compression molding operation comprising placing the coated granulated magnet powder particles in a mold (10, 15) configured to allow for pressurization and compressively deforming the coated granulated magnet powder particles with the mold, thereby producing the rare earth magnet (1) (FIG. 1(D)).

In this configuration, the coating is formed not to cover each rare earth magnet powder particle, but to cover the surface of each granulated magnet powder particle comprising a plurality of rare earth magnet powder particles bound in layers and stacked in a stacking direction, which allows for a decrease in the amount of insulating material required to maintain the thickness of each of the insulating coatings in the rare earth magnet, and an increase in the volume ratio of rare earth magnet powder particles. This minimizes the deterioration of magnetic properties of the rare earth magnet caused by the addition of the insulating material, improving the magnetic properties of the rare earth magnet. In other words, this configuration allows for an increase in the thickness of each coating without increasing the volume ratio of coatings, which prevents the occurrence of breaks in the coatings when the coated granulated magnet powder particles spread in a direction perpendicular to the pressing direction during a molding operation. This suppresses an increase in eddy current loss.

Preferably, the above rare earth magnet may be further configured such that the step of adding the insulating material in order to produce the granulated magnet powder particles comprises spraying a first dispersion solution containing a binding agent, the binding agent including a substance that decomposes at a temperature below a heat input temperature during the compression molding operation without leaving any residue, to the flake-shaped rare earth magnet powder particles that are caused to be tumbling and flowing, thereby binding the flake-shaped rare earth magnet powder particles in layers.

In this configuration, the binding agent is thermally decomposed by heat input during the compression molding operation with no residue left in the coatings, which ensures the insulation of the coatings, suppressing an increase in eddy current loss. In addition, this configuration decreases the volume ratio of coatings, improving the magnetic properties of the rare earth magnet.

Preferably, the above rare earth magnet may be further configured such that the step of adding the insulating material in order to produce the coated granulated magnet powder particles comprises spraying a second dispersion solution containing the insulating material and a binding agent to add the insulating material to the flake-shaped rare earth magnet powder particle, thereby producing the coated granulated magnet powder particles.

This configuration ensures that the insulating material is attached to the surfaces of granulated magnet powder particles with the binding agent, preventing the insulating material from spreading unevenly to cause breaks in the coatings.

Preferably, the above rare earth magnet may be further configured such that the step of performing the compression molding operation comprises: performing a first molding operation which includes placing the coated granulated magnet powder particles in the mold (10) configured to allow for pressurization in a first direction, and applying pressure to the coated granulated magnet powder particles in the mold in the first direction to produce a first molded product (6) (FIG. 1(D)); and performing a second molding operation which includes applying pressure to the first molded product in second direction that intersects with the first direction, thereby plastically deforming the first molded product to produce the rare earth magnet (FIG. 1(F)).

In this configuration, in the second molding operation, the coated granulated magnet powder particles of the first molded product spread in the third direction which is perpendicular to the first and second directions causing the thicknesses of the coatings to become properly thin, which minimizes the deterioration of magnetic properties of the rare earth magnet. Moreover, the second molding operation includes applying pressure to the first molded product in the second direction that intersects with the first direction, i.e., the pressing direction in the first molding operation, which prevents the thicknesses of the coatings in the first direction from becoming thinner too much, thereby suppressing an increase in eddy current loss.

### Effect of the Invention

As described above, the present invention can be embodied as a rare earth magnet and a method for manufacturing the same, which achieve both high magnetic properties and low eddy current loss.

### BRIEF DESCRIPTION OF THE DRAWINGS

FIG. 1 is an explanatory diagram showing a method for manufacturing a rare earth magnet according to an embodiment of the present invention, and includes FIGS. 1(A) to 1(F);

FIG. 2 shows a schematic diagram of a tumble flow device; and

FIG. 3 includes FIGS. 3A and 3B, where FIG. 3A is a schematic cross-sectional view of a coated granulated magnet powder particle according to the present invention, and FIG. 3B is a schematic cross-sectional view of coated magnet powder particles according to a comparative example.

### DESCRIPTION OF THE PREFERRED EMBODIMENT(S)

Embodiments of the present invention will be described below, with reference to the appended drawings.

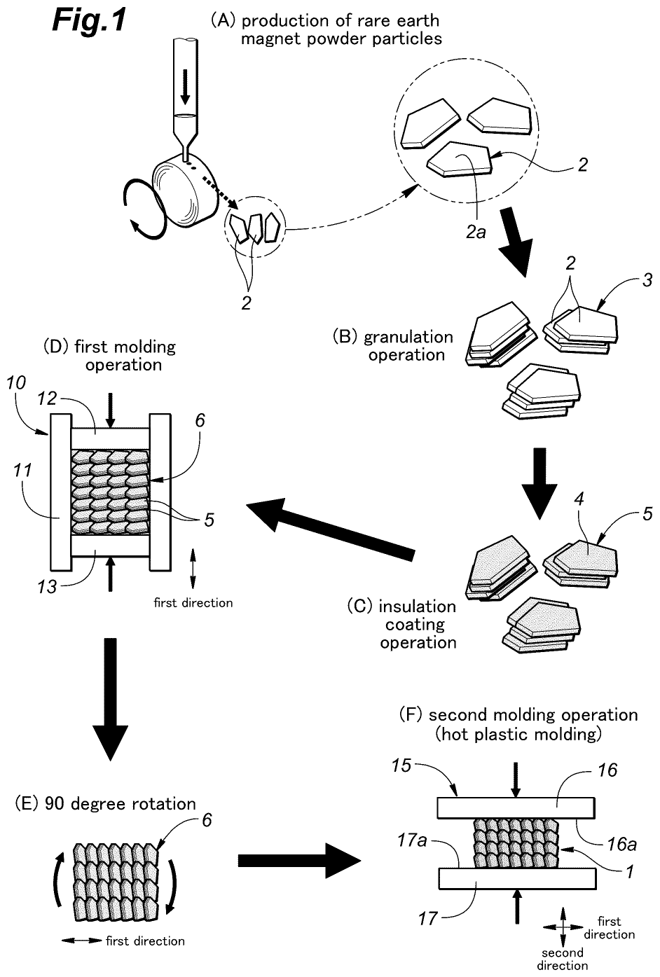

First, a manufacturing method of a rare earth magnet 1 of an embodiment of the present invention will be described below. FIG. 1 is an explanatory diagram showing a method for manufacturing a rare earth magnet of the embodiment of the present invention. As shown in FIG. 1(A), the first process is a step of producing rare earth magnet powder particles 2. This process produces rare earth magnet powder particles 2 to be used.

Examples of materials of the rare earth magnet powder particles 2 include, but not limited to, a neodymium magnet (Nd—Fe—B magnet, or more precisely Nd₂Fe₁₄B). An example of a method of manufacturing rare earth magnet powder particles 2 from a raw material of rare earth magnets is the melt spinning method. The melt spinning method includes spraying a high-temperature molten alloy onto a cooled roll for rapid cooling, thereby producing fine magnetic powder particles for magnets in the form of flakes (thin flakes) containing Nd—Fe—B crystals.

The rare earth magnet powder particles 2 produced in the process are isotropic rapid-cooled powder particles with non-aligned crystal directions, and each of the particles is flake-shaped, and thus has main surfaces 2a. The term “main surface 2a” is defined herein as each pair of the largest opposing flat surfaces. Each of the rare earth magnet powder particles 2 has an aspect ratio of approximately 1 (e.g., 0.7 to 1.0) when viewed from a direction perpendicular to the main surfaces 2a. The term “aspect ratio” refers to a ratio of the short diameter (minor axis diameter) to the long diameter (major axis diameter) of an object, and is expressed as b/a, where “a” is a long diameter and “b” is a short diameter. The term “major axis (major axis diameter)” refers to the maximum Feret diameter, and the term “minor axis (minor axis diameter)” refers to the minimum Feret diameter. The method for measuring the major and minor axes is compliant with the provisions of JIS Z 8890:2017 “Particle characterization of particulate systems.”

Next, as shown in FIG. 1B, a granulation operation is performed, which operation involves binding a plurality of rare earth magnet powder particles in layers to produce granulated magnet powder particles 3, each including bound rare earth magnet powder particles in granulated form. A method for forming granulated magnet powder particles 3 includes mixing a binding agent with a solvent, and stirring the mixture to produce a binder dispersion solution (first dispersion solution). Examples of the solvent include, but not limited to, isopropyl alcohol (also known as 2-propanol or IPA). The binding agent is added to increase the binding between the rare earth magnet powder particles 2. The binding agent is preferably decomposed and removed by heating during a molding operation to produce a rare earth magnet 1. Thus, it is preferable to select, as a binding agent, a substance that exhibits good thermal decomposition, i.e., that decomposes at a temperature below a heat input temperature during the molding operation without leaving any residue after molding. In the present embodiment, an acrylic binding agent, which is a binding agent made from acrylic polymer, is used as the binding agent, but not limited thereto.

After the preparation of the binder dispersion solution, this method further includes adding the binding agent to the rare earth magnet powder particles 2 by spraying the binder dispersion solution containing the binding agent to the rare earth magnet powder particles 2 that are caused to be tumbling and flowing by using a tumble flow device 20.

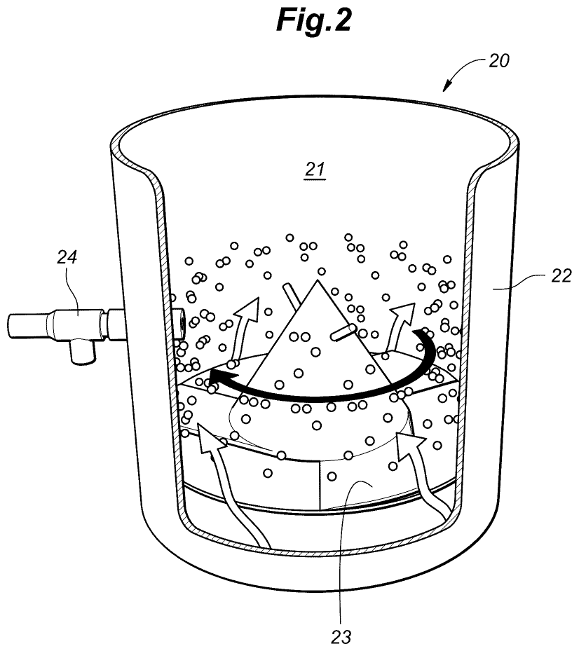

FIG. 2 shows a schematic diagram of a tumble flow device 20. As shown in FIG. 2, the tumble flow device 20 comprises a body housing 22 that defines a fluidized bed 21, a blade rotor 23 rotatably provided at a bottom of the fluidized bed 21, and a spray nozzle 24 provided on the lower side of the body housing 22. The spray nozzle 24 is attached to the body housing 22 in a horizontal orientation so that the nozzle faces downward towards the bottom of the fluidized bed 21 at a location above the blade rotor 23.

Air is supplied from the bottom of the body housing 22, and the rotation of the blade rotor 23 forces the rare earth magnet powder particles 2 to tumble and flow in the fluidized bed 21. With the air and the rare earth magnet powder particles 2 flowing in a swirling motion, the binder dispersion solution is sprayed from the spray nozzle 24 to the bottom of the fluidized bed 21, causing the binder dispersion solution to adhere to the surfaces of the rare earth magnet powder particles 2. During this process, when the rare earth magnet powder particles 2 tumbling and flowing, come into contact with each other on the main surfaces 2a, the rare earth magnet powder particles 2 are bound to each other in layers to form granulated magnet powder particles 3 each including several layers of rare earth magnet powder particles 2.

The granulation operation includes adding the binder dispersion solution and causing the rare earth magnet powder particles 2 to tumble and flow such that the granulated magnet powder particles 3 have thicknesses of 40 μm to 300 μm, in the stacking direction; that is, each of the granulated magnet powder particles 3 includes several rare earth magnet powder particles 2. The range of thickness is smaller than particle sizes of the rare earth magnet powder particles 2. In other words, the steps of adding the binder dispersion solution and causing the rare earth magnet powder particles 2 to tumble and flow are carried out such that the thicknesses of granulated magnet powder particles 3 does not become greater than the particle sizes of the rare earth magnet powder particles 2.

Next, as shown in FIG. 1(C), an insulation coating operation is performed to form an insulation coating on the surfaces of granulated magnet powder particles 3. This operation involves adding an insulating material to granulated magnet powder particles 3 so that a coating 4 is formed on a surface of each granulated magnet powder particle 3, to thereby produce coated granulated magnet powder particles 5 with the coatings 4 formed thereon.

Examples of preferable insulating materials include, but not limited to, alkali metal fluorides or alkaline earth metal fluorides. In the present embodiment, calcium fluoride (CaF₂), which is an alkaline earth metal fluoride, is used as the insulating material, but the insulating material is not limited to calcium fluoride. In some cases, the insulating material may be an alkaline earth metal fluoride (e.g., magnesium fluoride, barium fluoride, or strontium fluoride), an alkaline metal fluoride (e.g., lithium fluoride), or a combination (i.e., mixture) thereof.

The insulation coating operation for forming a coating 4 on the surface of each granulated magnet powder particle 3 involves the following steps: first, mixing insulation particles made of calcium fluoride and a binding agent with a solvent and stirring the mixture to produce an insulator particle dispersion solution (second dispersion solution). Examples of the solvent include, but not limited to, isopropyl alcohol (also known as 2-propanol or IPA). The binding agent is added to increase the binding between the insulation particles and the rare earth magnet powder particles for forming the granulated magnet powder particles 3. The binding agent is preferably decomposed and removed by heating during a molding operation to produce a rare earth magnet 1. Thus, it is preferable to select, as a binding agent, a substance that exhibits good thermal decomposition, i.e., that decomposes at a temperature below a heat input temperature during the molding operation without leaving any residue after molding. In the present embodiment, an acrylic binding agent, which is a binding agent made from acrylic polymer, is used as the binding agent, but not limited thereto.

After the preparation of the binder dispersion solution, this method further includes adding an insulating material to the granulated magnet powder particles 3 by spraying the binder dispersion solution containing the insulation particles and the binding agent to the granulated magnet powder particles 3 that are caused to be tumbling and flowing by using a tumble flow device 20. The tumble flow device 20 used in this operation may be the same as or different from the one used for granulation operation.

As shown in FIG. 2, air is supplied from the bottom of the body housing 22, and the rotation of the blade rotor 23 forces the granulated magnet powder particles 3 to tumble and flow in the fluidized bed 21. With the air and the granulated magnet powder particles 3 flowing in a swirling motion, the insulator particle dispersion solution is sprayed from the spray nozzle 24 to the bottom of the fluidized bed 21, causing the surfaces of the granulated magnet powder particles 3 to be coated with the insulation particles in an efficient manner.

The insulation coating operation for producing coated granulated magnet powder particles 5 includes adding the insulator particle dispersion solution such that the coatings 4 of the coated granulated magnet powder particles 5, the coatings including insulation particles, have thicknesses in a predetermined range (e.g., 200 nm to 2,000 nm).

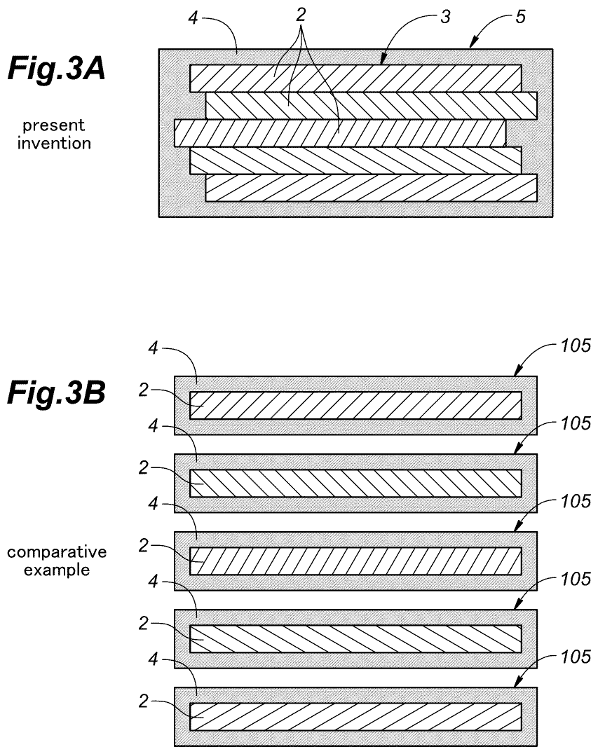

FIG. 3 includes FIGS. 3A and 3B, where FIG. 3A is a schematic cross-sectional view of a coated granulated magnet powder particle 5 according to the present invention, and FIG. 3B is a schematic cross-sectional view of coated magnet powder particles 105 according to a comparative example. First, the coated magnet powder particles 105 according to the comparative example will be described below.

As shown in FIG. 3B, each coated magnet powder particle 105 of the comparative example is coated on the surface of the rare earth magnet powder particle 2 such that the coating 4 has a predetermined thickness. When the coated magnet powder particles 105 form a stack, two layers of the coating 4 are interposed between the rare earth magnet powder particles 2 that are adjacent to each other in the thickness direction. Each of the coatings 4 made of the insulating material is rather thick, which means an increase in the volume ratio occupied by the insulating coatings and a decrease in the volume ratio of the rare earth magnet powder particles 2. This results in a deterioration of magnetic properties of the rare earth magnet.

In contrast, as shown in FIG. 3A, the coating 4 of each of the coated granulated magnet powder particles 5 according to the embodiment of the present invention, does not cover each rare earth magnet powder particle 2, but rather covers the surfaces of the granulated magnet powder particles 3 formed of the stacked rare earth magnet powder particles 2. This results in a decrease in the amount of insulating material required to maintain the thickness of each of the insulating coatings in the rare earth magnet 1, and an increase in the volume ratio of rare earth magnet powder particles 2, which minimizes the deterioration of magnetic properties of the rare earth magnet 1 caused by the addition of the insulating material, improving the magnetic properties of the rare earth magnet 1. In other words, this configuration allows for an increase in the thickness of each of the coatings 4 without increasing the volume ratio of the coatings 4, which prevents the occurrence of breaks in the coatings when the granulated magnet powder particles spread in a direction perpendicular to the pressing direction in a process of plastic molding. This suppresses an increase in eddy current loss.

Referring back to FIG. 1, as shown in FIG. 1 (D), a first molding operation for forming (molding) coated granulated magnet powder particles 5 is performed. This operation includes placing the coated granulated magnet powder particles 5 in the first mold 10 (hot press machine), and applying pressure to the coated granulated magnet powder particles 5 with the first mold 10 in a first direction, thereby compressively deforming the coated granulated magnet powder particles 5 to produce a first molded product 6 of the rare earth magnet 1 in which the coated granulated magnet powder particles 5 have been densified.

The first mold 10 includes a cylindrical mold body 11 with a cross-sectional shape conforming to the shape of the first molded product 6, and an upper mold 12 and a lower mold 13 capable of applying a compressive force in the first direction to an object in the mold body 11. Thus, the first molding operation includes applying pressure to the coated granulated magnet powder particles 5 while restricting deformation of the coated granulated magnet powder particles 5 in a direction perpendicular to the first direction, thereby forming the first molded product 6. In the present embodiment, the first direction is a vertical direction, but is not limited thereto.

The first molding operation includes processing, by hot press molding, the coated magnet powder particles 5 into the first molded product 6, in which the first mold 10 is heated to a predetermined temperature and a predetermined pressure is applied for a predetermined time. When being compressively deformed by the pressure, the coated granulated magnet powder particles 5 in the first mold 10 are oriented such that the main surfaces 2a of each of the rare earth magnet powder particles 2 face the first direction, resulting in that the coated granulated magnet powder particles 5 are stacked on each other in the direction perpendicular to the main surface 2a (i.e., the first direction).

In the first molded product (6) of the rare earth magnet 1, the rare earth magnet powder particles 2 are stacked in the direction perpendicular to their main surfaces 2a (first direction).

The first molding operation for forming the first molded product 6 is performed by using a process of hot compression, in which the coated granulated magnet powder particles 5 are compressed and deformed at high temperatures, and the first mold 10 is heated to a predetermined temperature. The predetermined temperature is preferably a temperature within a range from about 600° C. to about 700° C., preferably 640° C.

After the first molding operation, a rotation operation is performed in which the resulting first molded product 6 is removed from the first mold 10 and rotated 90 degrees, as shown in FIG. 1(E). The rotation of the first molded product 6 is performed around an axis of rotation in the horizontal plane, i.e., around an axis parallel to the main surfaces 2a of each of the rare earth magnet powder particles 2. In the present embodiment, the angle of rotation of the first molded product 6 is 90 degrees. Although the angle is not limited to 90 degrees, the angle of rotation is preferably close to 90 degrees, and more preferably 90 degrees, which is perpendicular to the first direction.

Then, as shown in FIG. 1(F), a second molding operation for molding the first molded product 6 is performed. This operation includes, after rotating the first molded product 6 to the angle as shown in FIG. 1 (E), placing the first molded product 6 in a second mold 15, and applying pressure to the first molded product with the second mold 15 in a second direction, the second direction intersecting the first direction, which is the pressing direction in the first molding operation (i.e., the direction of stacking of the rare earth magnet powder particles 2), thereby plastically deforming the first molded product 6 to produce the rare earth magnet 1 (that is a second molded product).

The rotation operation shown in FIG. 1(E) is required since the pressing direction of the second molding operation shown in FIG. 1(F) is the same vertical direction as that of the first molding operation. Thus, in some cases, the rotation operation shown in FIG. 1(E) is not required when the pressing direction of the second molding operation is different from that of the first molding operation, e.g., when the pressing direction of the second molding operation is a horizontal direction.

The second mold 15 includes an upper mold 16 and a lower mold 17, which are opposite to each other. The upper mold 16 and lower mold 17 have an upper pressure surface 16a and a lower pressure surface 17a which conform to the shape of the first molded product 6 and are capable of applying pressure to the first molded product 6 in the second direction (vertical in the present embodiment). Since, in the present embodiment, the first molded product 6 has a rectangular shape, the upper mold 16 and the lower mold 17 have an upper pressure surface 16a and a lower pressure surface 17a, which are a pair of horizontal surfaces facing and parallel to each other, and configured to apply a compression force to the first molded product 6 in a vertical direction, which is perpendicular to the first direction.

The second molding operation includes pressing the first molded product 6 without restricting deformation of the first molded product 6 in the direction perpendicular to the second direction. Thus, in the second molding operation, the first molded product 6 is plastically deformed by compressing the first molded product 6 in the vertical direction, which is the pressing direction of the second molding operation, while allowing the first molded product 6 to deform in the horizontal direction perpendicular to the vertical direction. Specifically, for each of the rare earth magnet powder particles 2 in the rare earth magnet 1, the thickness (dimension in the first direction) becomes thicker than when being present in the first molded product 6 before the second molding operation. The aspect ratio of each of the rare earth magnet powder particle 2 in the rare earth magnet 1 viewed from the first direction becomes smaller than when being present in the first molded product 6 before the second molding operation. The aspect ratio of each of the rare earth magnet powder particles 2 in the rare earth magnet 1 is preferably smaller than 1, e.g., 0.15 to 0.5.

In the process of hot plastic molding, the rare earth magnet powder particles 2 of the first molded product 6 develop magnetic anisotropy (uniaxial anisotropy) with the c-axis directions (magnetization easy direction) of the crystal grains oriented parallel to the pressing direction. The rare earth magnet powder particles 2 of the rare earth magnet 1 are magnetized in the direction of this magnetic anisotropy.

In this way, in the second molding operation, the first molded product 6 is pressed in the second direction, which intersects the first direction, and plastically deformed. This causes the rare earth magnet powder particles 2 and the coating 4 around the particles to spread in the direction perpendicular to the second direction, i.e., the first direction and a third direction. In other words, the coating 4 between the rare earth magnet powder particles 2 adjacent to each other in the first direction becomes thinner by spreading in the third direction, while not spreading in the second direction. This prevents the coating 4 from becoming too thin in the first direction, which reduces an increase in eddy current loss. Details of this effect will be discussed later.

The second molding operation is performed by using a process of hot compression, in which the second mold 15 is heated to a predetermined temperature to compress and deform the first molded product 6, more specifically, by using a process of hot plastic molding, in which the first molded product 6 is plastically deformed at a higher temperature than the first molding operation. The temperature of the second mold 15 in the second molding operation is preferably a temperature at which some of the crystal grains of the rare earth magnet powder particles 2 undergo a phase change to the liquid phase, e.g., about 850 degrees. The process allows the rare earth magnet powder particles 2 to be plastically deformed with a high compaction rate. In the present embodiment, the first molded product 6 of the rare earth magnet 1 is plastically processed with a compaction rate of about 70% in the second molding operation.

Next, effects achieved by the rare earth magnet 1 manufactured as described above and by the method of manufacturing the same will be described.

As shown in FIG. 3A, a rare earth magnet 1 comprises coated granulated magnet powder particles 5, each of which comprises a granulated magnet powder particle 3 and a coating 4 of an insulating material on a surface thereof, the granulated magnet powder particle including a plurality of flake-shaped rare earth magnet powder particles 2 bound in layers and stacked in a stacking direction. This allows for a decrease in the amount of insulating material required to maintain the thickness of each of the insulating coatings in the rare earth magnet 1, and an increase in the volume ratio of rare earth magnet powder particles 2. This minimizes the deterioration of magnetic properties of the rare earth magnet 1 caused by the addition of the insulating material, improving the magnetic properties of the rare earth magnet. In other words, this configuration allows for an increase in the thickness of each coating 4 without increasing the volume ratio of coatings, which prevents the occurrence of breaks in the coatings 4 when the coated granulated magnet powder particles 5 spread in a direction perpendicular to the pressing direction during a molding operation. This suppresses an increase in eddy current loss of the rare earth magnet.

In the embodiment as described above, the granulated magnet powder particle 3 has a thickness of 40 μm to 300 μm in the stacking direction, and thus each granulated magnet powder particle 3 comprises several rare earth magnet powder particles 2 bound in layers. This allows for an effective decrease in the volume ratio of coatings.

In the embodiment as described above, the granulated magnet powder particle 3 has a thickness in the stacking direction that is smaller than particle sizes of the rare earth magnet powder particles thereof. This configuration allows for a decrease in the volume ratio of coatings 4 in the rare earth magnet 1 without compromising the ease of orientation of coated granulated magnet powder particle 5 in a molding operation.

As shown in FIG. 1, a method for manufacturing the rare earth magnet 1 comprises: binding rare earth magnet powder particles 2 in layers to produce granulated magnet powder particles 3, which is the step of FIG. 1(B); and adding an insulating material to the granulated magnet powder particles to produce coated granulated magnet powder particles 5, each comprising the rare earth magnet powder particles and a coating 4 of the insulating material on a surface thereof, which is the step of FIG. 1(C), thereby producing the rare earth magnet 1 configured as described above. This configuration can achieve both high magnetic properties and low eddy current loss of the rare earth magnet 1.

The step of adding the insulating material in order to produce the granulated magnet powder particles 3 comprises spraying a first dispersion solution containing a binding agent, the binding agent including a substance that decomposes at a temperature below a heat input temperature during the compression molding operation without leaving any residue, to the rare earth magnet powder particles 2 that are caused to be tumbling and flowing, thereby binding the rare earth magnet powder particles 2 in layers. In this configuration, the binding agent is thermally decomposed by heat input during the compression molding operation with no residue left in the coatings 4, which ensures the insulation of the coatings 4, suppressing an increase in eddy current loss. In addition, this configuration decreases the volume ratio of coatings 4, improving the magnetic properties of the rare earth magnet 1.

The step of adding the insulating material in order to produce the coated granulated magnet powder particles 5 comprises spraying a second dispersion solution containing the insulating material and a binding agent to add the insulating material to the rare earth magnet powder particle. This configuration ensures that the insulating material is attached to the surfaces of granulated magnet powder particles 3 with the binding agent, preventing the insulating material from spreading unevenly to cause breaks in the coatings 4.

As shown in FIG. 1, the step of performing the compression molding operation comprises: performing a first molding operation which includes applying pressure to the coated granulated magnet powder particles 5 in the first direction to produce a first molded product 6 as shown in FIG. 1(D); and performing a second molding operation which includes applying pressure to the first molded product 6 in second direction that intersects with the first direction, thereby plastically deforming the first molded product 6 as shown in FIG. 1(F). In this configuration, in the second molding operation, when being compressed in the second direction, the coated granulated magnet powder particles 5 of the first molded product spread in the third direction which is perpendicular to the first and second directions. This prevents the thicknesses of the coatings 4 on the main surfaces 2a of the rare earth magnet powder particles 2 (i.e., the thicknesses in the first direction) from easily becoming thinner. This further prevents the occurrence of breaks in the coatings 4, which suppresses an increase in eddy current loss. Thus, this configuration allows for a decrease in the amount of insulating material to be added, thereby minimizing the deterioration of magnetic properties of the rare earth magnet 1 caused by the addition of the insulating material.

Some embodiments of the present invention have been described. However, the present invention is not limited to those specific embodiments, and may be embodied with various modifications. For example, in the above embodiments, since the rare earth magnet 1 has a rectangular prismatic shape, the first molded product 6 is rotated by 90 degrees as shown in FIG. 1(D). However, as described earlier, the rotation angle is not limited to this angle. For example, when the first molded product 6 exhibits an octagon shape as viewed horizontally, the rotation angle may be 90 or 45 degrees. When the first molded product 6 exhibits a 16-sided polygon shape as viewed horizontally, the rotation angle may be any of 22.5, 45, 67.5 or 90 degrees. When the first molded product 6 exhibits a circular shape as viewed horizontally, the rotation angle may be any angle between 0 degree to 180 degrees. Generally, various changes and modifications may be made to features of the embodiments such as specific configuration, location, quantity, and material of each component or element in the embodiments without departing from the scope of the present invention. In the above-described embodiments, not all elements included therein are essential. Thus, various modifications including elimination of some elements may be made to the embodiments as appropriate.

### GLOSSARY

1 rare earth magnet
2 rare earth magnet powder particle
3 granulated magnet powder particle
4 coating
5 coated magnet powder particle
6 first molded product
10 first mold
15 second mold
20 tumble flow device

1. A rare earth magnet comprising coated granulated magnet powder particles, each of which comprises a granulated magnet powder particle and a coating of an insulating material on a surface thereof, the granulated magnet powder particle including a plurality of flake-shaped rare earth magnet powder particles bound in layers and stacked in a stacking direction.

2. The rare earth magnet as claimed in claim 1, wherein the granulated magnet powder particle has a thickness of 40 μm to 300 μm in the stacking direction.

3. The rare earth magnet as claimed in claim 1, wherein the granulated magnet powder particle has a thickness in the stacking direction that is smaller than particle sizes of the rare earth magnet powder particles thereof.

4. A method for manufacturing a rare earth magnet comprising:
binding a plurality of flake-shaped rare earth magnet powder particles in layers to produce granulated magnet powder particles, each of which is formed by a plurality of the flake-shaped rare earth magnet powder particles stacked in a stacking direction;
adding an insulating material to the granulated magnet powder particles to produce coated granulated magnet powder particles, such that each of the coated granulated magnet powder particles comprises the flake-shaped rare earth magnet powder particles and a coating of the insulating material on a surface thereof; and
performing a compression molding operation, the compression molding operation comprising placing the coated granulated magnet powder particles in a mold configured to allow for pressurization and compressively deforming the coated granulated magnet powder particles with the mold, thereby producing the rare earth magnet.

5. The method as claimed in claim 4, wherein the step of adding the insulating material comprises spraying a first dispersion solution containing a binding agent, the binding agent including a substance that decomposes at a temperature below a heat input temperature during the compression molding operation without leaving any residue, to the flake-shaped rare earth magnet powder particles that are caused to be tumbling and flowing, thereby binding the flake-shaped rare earth magnet powder particles in layers.

6. The method as claimed in claim 4, wherein the step of adding the insulating material comprises spraying a second dispersion solution containing the insulating material and a binding agent to add the insulating material to the flake-shaped rare earth magnet powder particle, thereby producing the coated granulated magnet powder particles.

7. The method as claimed in claim 4, wherein the step of performing the compression molding operation comprises:
performing a first molding operation which includes placing the coated granulated magnet powder particles in the mold configured to allow for pressurization in a first direction, and applying pressure to the coated granulated magnet powder particles in the mold in the first direction to produce a first molded product; and
performing a second molding operation which includes applying pressure to the first molded product in second direction that intersects with the first direction, thereby plastically deforming the first molded product to produce the rare earth magnet.
